(19) United States
(12) Patent Application Publication
(10) Pub. No.: US 2004/0126000 A1
(43) Pub. Date: Jul. 1, 2004

(54) Image processing apparatus, method, program, and recording medium

(75) Inventor: Sumiya Nagatsuka, Tokyo (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: KONICA MINOLTA HOLDINGS, INC., Tokyo (JP)

(21) Appl. No.: 10/735,027

(22) Filed: Dec. 12, 2003

(30) Foreign Application Priority Data
Dec. 24, 2002 (JP) JP2002-372883

(51) Int. Cl. G06K 9/00

(52) U.S. Cl. 382/132

(57) ABSTRACT

An image processing apparatus for processing an image composed of two-dimensional image data corresponding to an image reading area of an image reader, comprising: a specifying device for specifying a output-size within the image reading area of the image reader; a determining device for selecting a part of the two-dimensional image data in accordance with the output-size, analyzing image data in the selected part of the two-dimensional image data, and determining a processing condition for the image data in the selected part on basis of the analyzing result; and a processing device for processing the image data in the selected part with the determined processing condition.

### FIELD OF THE INVENTION

This invention relates to an apparatus, a method, a program, and a recording medium for image processing.

### BACKGROUND OF THE INVENTION

Conventionally, radiographic apparatus (Roentgen and CT apparatus), MRI (Magnetic Resonance Imaging) apparatus, and the like have been well-known as medical imaging apparatus that use radio rays such as X rays. The medical imaging apparatus comprises an apparatus for reading patient images by X rays (an image reader) and an apparatus for controlling this reading apparatus. The controlling apparatus takes in image data from the image reader and outputs the data to an image processing apparatus. The image processing apparatus performs various kinds of image processing such as frequency processing and gradation processing and outputs the resulting images to films or a display unit. Doctors can read images on the films or on the display unit for analysis and diagnosis.

In this case, the image processing apparatus processes medical images under image processing conditions which distinguish the region of interest (ROI) from the other areas to facilitate doctors to analyze images. Therefore, the image processing apparatus determines image processing conditions to the purpose of diagnosis (which is disclosed for example by Japanese Non-Examined Patent Publication H04-341246).

(Problems to be Resolved by the Invention)

However, the conventional image processing apparatus uses the area of a whole image (17 inches by 17 inches maximum) read by the above image reader as an image area for determination of an image processing condition. Therefore, even when the size of an image to be output to a display unit or film output unit is smaller (than the whole image size read by the image reader, e.g. 14 inches by 17 inches maximum), the image processing apparatus processes the images under the same image processing condition as that when the image processing apparatus processes the whole read images. This cannot offer a stable image processing result that doctors want.

### SUMMARY OF THE INVENTION

An object of this invention is to limit an area used for determination of an image processing condition according to the output size of images read by the image reader and to process images under an image processing condition fit for image data of the limited image area.

(Means of Solving the Problems)

To solve the above problem, this invention is characterized by the following:

(1) An image processing apparatus which receives images read by an image reading apparatus, processes the images, and outputs the results to an output unit, comprising

a specifying means which specifies an output image size in the scanning range of said reading apparatus,

a process condition determining means which limits an area used for determination of a condition to process said-read image according to the output size specified by said specifying means, analyzes the image data in the limited process area, and determines an image processing condition, and

an image processing means which processes a read image in the limited process area under the image processing condition determined by said condition determining means.

(2) An image processing method of processing images read by an image reading apparatus and outputting resulting images to an output unit, further comprising the steps of specifying an output image size in the scanning range of said reading apparatus,

limiting an area used for determination of a condition to process said read image according to the output size specified by said specifying step, analyzing image data in the limited process area, and determining an image processing condition, and

processing a read image in the limited process area under the image processing condition determined by said condition determining step.

(3) A program running on a computer for controlling an image processing apparatus which processes images read by an image reading apparatus and outputs the resulting images to an output unit, wherein said program comprises

a specifying function which specifies an output image size in the scanning range of said reading apparatus,

a process condition determining function which limits an area used for determination of a condition to process said read image according to the output size specified by said specifying function, analyzes image data in the limited process area, and determines an image processing condition, and

an image processing function which processes a read image in the limited process area under the image processing condition determined by said condition determining function.

(4) A recording medium storing a program which can be read by a computer for controlling an image processing apparatus which processes images read by an image reading apparatus and outputs the resulting images to an output unit, wherein said program comprises

a specifying function which specifies an output image size in the scanning range of said reading apparatus,

a process condition determining function which limits an area used for determination of a condition to process said read image according to the output size specified by said specifying function, analyzes image data in the limited process area, and determines an image processing condition, and

an image processing function which processes a read image in the limited process area under the image processing condition determined by said condition determining function.

In accordance with (1) to (4), this invention limits an area used for determination of a condition of processing said read image according to the output size specified in the scanning range of the reading apparatus, analyzes image data in the limited process area, determines an image processing condition, and performs image processing on the process area under the image processing condition. Accordingly, for example, when the image read by a medical image reading apparatus is greater than the size of an image to be output by the output unit, the image processing apparatus limits an image area for determination of an image processing condition according to the specified output size (e.g. 14 inches by 17 inches) in the scanning range (e.g. 17 inches by 17 inches) of the image reading apparatus, analyzes image data in the limited process area, determines an image processing condition, and performs image processing on the process area under the image processing condition. Therefore, this invention can present stable image processing results that doctors want.

### BRIEF DESCRIPTION OF THE DRAWINGS

FIG. 1 shows a functional block diagram of an image processing apparatus 10.

FIG. 2 shows a flow chart of image processing.

FIG. 3 shows a relationship between the read image size and the specified output size.

### DETAILED DESCRIPTION OF PREFERRED EMBODIMENTS

The image processing apparatus which is an embodiment of this invention will be described below in further detail with reference to the accompanying drawings.

In the description of the preferred embodiments of this invention, the medical image input unit is a medical image reading apparatus that reads patient images and inputs data of the read images to the image processing apparatus or the like. The medical image output unit is a medical image display unit or a film output unit that output images. Further, the medical image input unit can include an image control unit, a medical imaging apparatus or the like which inputs images through a communication control section which is connected to a network.

Although the image processing apparatus 10 of this embodiment is provided separately from a medical image input unit such as a medical imaging apparatus and connected to it via an interface section 16, the image processing apparatus 10 can be housed in the medical image input unit.

First, the configuration of this embodiment is explained below.

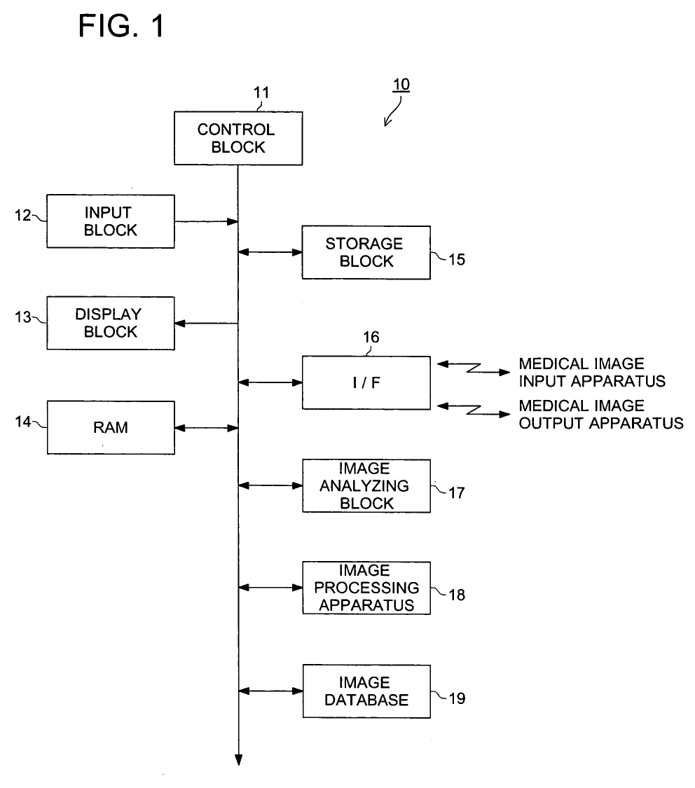

FIG. 1 shows a functional block diagram of the image processing apparatus 10 of this embodiment.

Referring to FIG. 1, the image processing apparatus 10 comprises a control block 11, an input block 12, a display block 13, random access memory (RAM) 14, a storage block 15, an interface (I/F) block 16, an image analyzing block 17, an image processing block 18, and an image database (DB) 19.

The control block 11 comprises a central processing unit (CPU) and other components and works to read a system program and various processing programs from the storage block 15, develop them on RAM 14, and control operations of the above blocks collectively by the processing programs. Further, the control block 11 executes various kinds of processing by programs which are developed on RAM 14, stores the result on RAM 14, displays the result of processing on the display block 13, and transfers the result of processing from RAM 14 to a preset location of the storage block 15 for saving.

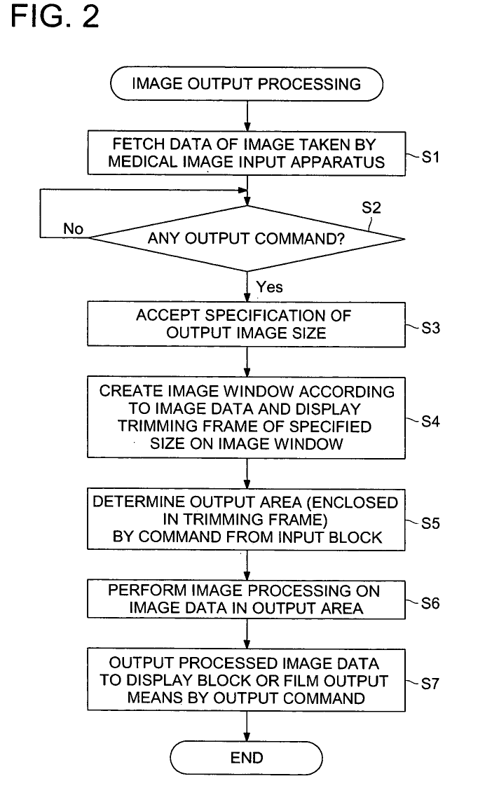

Furthermore in the image output processing (see FIG. 2), the control block 11 receives read image data from the medical image input unit through the interface (I/F) block 16 and stores the data on RAM 14. The control block 11 receives an output size specified in the scanning range by the medical image input unit from the input block 12 and limits an area used for determination of an image processing condition according to the output size. The control block 11 causes the image analyzing block 17 to analyze image data in the limited processing area, determines an image processing condition according to the result of analysis, and causes the image processing block 18 to process image data in the output area under the image processing condition.

In other words, the input block 12 (a specifying device) has a function to specify an output image size. The image analyzing block 17 (a determining device) has a function to determine an image processing condition and the image processing block 18 (a processing device) has a function to process images.

The input block 12 contains a keyboard comprising cursor keys, digit keys, and function keys and sends a signal to the control block 11 when a key on the keyboard is pressed. The input block 12 can be equipped with a pointing device such as a mouse and a touch-sensitive panel or other input means if necessary.

The display block 13 mainly comprises a liquid crystal display (LCD) unit, cathode-ray tube (CRT) unit, or the like. The display block 13 displays, on the screen, images which are processed by the image processing block 18 and commands entered from the input block 12 according to the display signals sent from the control block 11.

RAM 14 provides an area to temporarily store a system program, a control program, input or output data, and parameters which are supplied from the storage block 15 and executable by the image processing apparatus 10.

The storage block 15 is equipped with a recording medium (not shown in the drawing) which stores programs and data in advance. The recording medium can be a magnetic or optical recording medium or semiconductor memory and provided in the recording block permanently or detachably. The recording medium stores a system program for the image processing apparatus 10, processing programs the system program can implement, and data processed by the processing programs. The processing programs are stored in the form of readable program codes in the storage block 15. The control block 11 implements operations by the program codes.

The I/F block 16 has input interface for connection to the medical image input apparatus and output interface for connection to the medical image output apparatus and works to transfer image data from the medical input unit to RAM and from RAM 14 to the medical output unit by commands sent from the control block 11.

The image analyzing block 17 receives image data and analyzes the image data by analytic parameters of image analysis commands from the control block 11. In further details, the image analyzing block 17 recognizes an significant area to diagnosis (ROI) from the area used for determination of an image processing condition according to the output size specified by the input block 12, creates a cumulative histogram in this ROI, determines the image processing condition of the image (e.g. gradation condition) according to the result of the cumulative histogram, and outputs the result of analysis to the control block 11.

The image processing section 18 performs various processing (such as frequency processing to control the sharpness of images, gradation processing to control image contrasts, or dynamic range compression to narrow the contrast of images of a dynamic range to a legible contrast range without degrading the detailed image contrast) on the entered image data by commands sent from the control block 11 under the image processing condition determined by the image analyzing block 17.

The database (DB) 19 stores entered image data by Save commands sent from the control block 11 and outputs selected image data to the display block 13 or to the image processing block 18 by Output commands sent from the control block 11.

Next, the operations of this embodiment are explained below assuming that the medical image input unit sends image data of 17 inches by 17 inches to the image processing apparatus 10, that programs for implementing processes listed in the flow chart are stored in program codes that the computer can read in the storage block 15, and that the control block 11 implements operations by the program codes.

FIG. 2 shows a flow chart of image processing that the control block 11 implements.

Referring to FIG. 2, when receiving data of a read image from the medical image input unit through the I/F block 16, the control block 11 temporarily stores the image data in RAM 14 (step S1). At step S2 (Yes), the control block 11 receives a command to output an image from the input block 12 and causes the medical input unit to specify an output size of image data in the scanning range. In other words, the control block 11 displays a size specification window (not shown in the drawing) which prompts the user to specify an output image size within the size (17 inches by 17 inches) of the entered image data and accepts the specified output size (e.g. 14 inches by 17 inches) from the input block 12 (step S3).

Next (at step S4), the control block 11 creates an image window (not shown in the drawing) which displays a picture image from image data which is temporarily stored in RAM 14, displays it on the display block 13 together with a trimming frame of the specified output size on the picture image. At step S5, the control block 11 moves the trimming frame on the picture image by commands from the input block 12 and determines an output area (enclosed in the trimming frame) to be output to the display block 13 or the medical image output unit. The control block 11 uses this determined output area as a processing area for determination of an image processing condition and outputs an Analyze Image command to the image analyzing block 17.

Next, the image analyzing block 17 analyzes the image data by specified parameters in the processing area which the control block 11 limited. In further details, the image analyzing block 17 recognizes an area significant to diagnosis (ROI) from image data in the limited processing area, creates a cumulative histogram in this ROI, determines the image processing condition of the image (e.g. gradation condition) according to the result of the cumulative histogram, and outputs the result of analysis to the control block 11.

The control block 11 controls the image processing section 18 to perform various kinds of processing (such as gradation processing to control image contrasts, frequency processing to control the sharpness of images, and dynamic range compression to narrow the contrast of images of a dynamic range to a legible contrast range without degrading the detailed image contrast) on the image data in the limited processing area under the image processing condition determined by the image analyzing block 17. (Step S6)

At step S7, the control block 11 outputs the image data processed by the image processing block 18 to the display unit 13 or to the medical output unit through the I/F block 16 by the Output command from the input block 12. Then the image output processing is complete.

As described above, image processing apparatus 10 causes the input block 12 to specify the size of an image to be output to the display unit 13 or to the medical output unit, limits the processing area used for determination of an image processing condition according to the specified output size, analyzes image data in the processing area by the image analyzing block 17, and determines the image processing condition. The image processing apparatus 10 causes the image processing section 18 to perform various kinds of processing such as gradation processing, frequency processing, and dynamic range compression on image data, and outputs the processed image data to a destination specified by the input block 12.

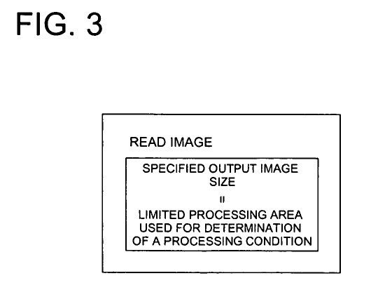

Accordingly, for example, even when the image read by a medical image reading apparatus is greater than the specified output image size as shown in FIG. 3, the image processing apparatus 10 limits an image area for determination of an image processing condition according to the specified output size (e.g. 14 inches by 17 inches) in the scanning range (e.g. 17 inches by 17 inches) of the image reading apparatus, determines an image processing condition according to the image data in the limited processing area, and performs image processing on the image data in the processing area under the image processing condition. Therefore, this invention can present stable image processing results that doctors want.

Although this embodiment limits the processing area by the output size, it is possible to change image processing conditions by output sizes.

However, it is to be understood that this invention is not intended to be limited to the above embodiment and variations may be made by one skilled in the art without departing from the spirit and scope of this invention.

(Effect of the Invention)

In accordance with the present invention, when the image read by a medical image reading apparatus is greater than the size of an image output by the output unit, the image processing apparatus limits an image area for determination of an image processing condition according to the specified output size (e.g. 14 inches by 17 inches) in the scanning range (e.g. 17 inches by 17 inches) of the image reading apparatus, analyzes image data in the limited process area, determines an image processing condition, and performs image processing on the process area under the image processing condition. Therefore, this invention can present stable image processing results that doctors want.

What is claimed is:

1. An image processing apparatus for processing an image composed of two-dimensional image data corresponding to an image reading area of an image reader, comprising:
a specifying device for specifying a output-size within the image reading area of the image reader;
a determining device for selecting a part of the two-dimensional image data in accordance with the output-size,
analyzing image data in the selected part of the two-dimensional image data, and determining a processing condition for the image data in the selected part on basis of the analyzing result; and
a processing device for processing the image data in the selected part with the determined processing condition.

2. The image processing apparatus of claim 1, wherein said image comprises X-ray image.

3. The image processing apparatus of claim 1, wherein said determining device recognizes a significant data to diagnosis form the selected part of the two-dimensional image data.

4. The image processing apparatus of claim 3, wherein said determining device creates a cumulative histogram of the significant data and determining the processing condition according to the result of the cumulative histogram.

5. The image processing apparatus of the claim 1, further comprising:
a display for displaying a picture image of the two-dimensional image data with a trimming frame according to the output-size.

6. A method for processing an image composed of two-dimensional image data, comprising the steps of:
reading the image composed of two-dimensional image data corresponding to an image reading area of an image reader;
specifying a output-size within the image reading area of the image reader;
selecting a part of the two-dimensional image data in accordance with the output-size;
analyzing image data in the selected part of the two-dimensional image data;
determining a processing condition for the image data in the selected part on basis of the analyzing result; and
processing the image data in the selected part with the determined processing condition.

7. The method of claim 6, wherein said image comprises X-ray image.

8. The method of claim 6, further comprising the step of:
recognizing a significant data to diagnosis form the selected part of the two-dimensional image data.

9. The method of claim 8, further comprising the step of:
creating a cumulative histogram of the significant data and determining the processing condition according to the result of the cumulative histogram.

10. The method of claim 6, further comprising the step of:
displaying a picture image of the two-dimensional image data with a trimming frame according to the output-size.

11. A computer program to control a computer to function as an image processor for processing an image composed of two-dimensional image data corresponding to an image reading area of an image reader, wherein the image processor comprising:
a specifying function for specifying a output-size within the image reading area of the image reader;
a determining function for selecting a part of the two-dimensional image data in accordance with the output-size,
analyzing image data in the selected part of the two-dimensional image data, and determining a processing condition for the image data in the selected part on basis of the analyzing result; and
a processing function for processing the image data in the selected part with the determined processing condition.

12. A recording medium, which comprises a program to control a computer to function as an image processor for processing an image composed of two-dimensional image data corresponding to an image reading area of an image reader, wherein the image processor comprising:
a specifying function for specifying a output-size within the image reading area of the image reader;
a determining function for selecting a part of the two-dimensional image data in accordance with the output-size, analyzing image data in the selected part of the two-dimensional image data, and determining a processing condition for the image data in the selected part on basis of the analyzing result; and
a processing function for processing the image data in the selected part with the determined processing condition.
